(19) United States
(12) Patent Application Publication
(10) Pub. No.: US 2021/0132326 A1
(43) Pub. Date: May 6, 2021

(54) IMAGING DEVICE

(71) Applicant: NIDEC COPAL CORPORATION, Tokyo (JP)

(72) Inventors: Yuta NAKAMURA, Tokyo (JP); Koichi KUBO, Tokyo (JP)

(73) Assignee: NIDEC COPAL CORPORATION, Tokyo (JP)

(21) Appl. No.: 16/478,644

(22) PCT Filed: Jan. 16, 2018
(86) PCT No.: PCT/JP2018/000898

§ 371 Date: Jul. 17, 2019

(30) Foreign Application Priority Data
Jan. 17, 2017 (JP) 2017-005481

(51) Int. Cl. G02B 7/09; G02B 7/02; G03B 5/00

(52) U.S. Cl. CPC G02B 7/09; G03B 2205/0015; G03B 5/00; G02B 7/028

(57) ABSTRACT

An imaging device comprising a substrate upon which an imaging unit is mounted; a lens barrel holding a lens; a lens flange holding the lens barrel; and a plate holding the substrate and the lens flange. The plate has a first holding section that impels either the plate or the lens flange in the optical axis direction and fixes same and holds the other out of the substrate and the lens flange so as to be movable in a direction perpendicular to the optical axis. The other out of the substrate and the lens flange is fixed to the plate.

### CROSS-REFERENCE TO RELATED APPLICATION

This application is a National Stage of International Application PCT/JP2018/000898, filed Jan. 16, 2018, which published as WO 2018/135452 on Jul. 26, 2018. The international application claims priority to Japanese Application No. 2017-005481 filed Jan. 17, 2017. All of these applications are herein incorporated by reference in their entirety.

### FIELD OF TECHNOLOGY

One aspect of the present invention relates to an imaging device.

### BACKGROUND

With an imaging apparatus at that has a lens barrel and the substrate on which the imaging element is mounted, it is necessary to adjust the position of the lens barrel in relation to the imaging element, and necessary to adjust the optical axis and focus. In the conventional imaging device, the optical axial position of the lens barrel would be adjusted, for example, while the substrate was held using a special jig. An imaging device of such a conventional structure is disclosed in, for example, Japanese Unexamined Patent Application Publication 2011-259101.

However, in recent years there has been the need for adjusting the optical axis and focus with even greater precision, and for features so as to not produce misalignment, in imaging devices used in automobiles, and the like. However, with the conventional imaging device, described above, high precision adjustment of the optical axis has not been easy. Moreover, it has required a jig for adjusting the optical axis, and the adjustment of the optical axis has been complex.

### SUMMARY

The present invention adopts means such as the following in order to solve the problem described above. Note that while in the explanation below reference symbols from the drawings are written in parentheses for ease in understanding the present invention, the individual structural elements of the present invention are not limited to those that are written, but rather should be interpreted broadly, in a range that could be understood technically by a person skilled in the art.

One means according to the present invention is

an imaging device, comprising
a substrate (5a) for mounting an imaging portion;
a lens barrel (3) for holding a lens group;
a lens flange (4) for holding the lens barrel; a plate (6) for holding the substrate and the lens flange, wherein:
the plate has a first holding portion (for example, substrate rearward biasing portions 6f and 6j) for holding either the substrate or the lens flange while biasing in the optical axial direction, and for holding the other, of the substrate or the lens flange, so as to enable movement in a direction that is perpendicular to the optical axis, wherein
the other, of the substrate or the lens flange, is secured to the plate.

The imaging device structured as described above enables suppression of misalignment, through stabilizing of the position of the substrate or the lens flange (for example, the substrate) when performing the optical axial adjustment by moving the substrate or lens flange (for example, the substrate) in a direction that is perpendicular to the optical axis. This enables the optical axial adjustment to be performed more easily and with greater precision than conventionally.

In the imaging device set forth above, preferably the plate is metal and arranged so as to cover the substrate.

The imaging device structured as described above can prevent leakage, to the outside, of electromagnetism that is produced from the electronic components, and the like, that are mounted on the substrate, and can prevent the incursion of noise from the outside into the electronic components or imaging element.

In the imaging device set forth above, preferably:

the first holding portion is a leaf spring portion (for example, substrate rearward biasing portions 6f, 6j) of the plate.

In the imaging device set forth above, either the substrate or the lens flange is biased by the leaf spring portions of portions of the plate, enabling a configuration that holds either the substrate or the lens flange with stability, without increasing the number of components.

The imaging device set forth above preferably further comprises an electronic component; and the plate further has a heat conducting portion that contacts the electronic component.

The imaging device structured as set forth above enables a structure wherein heat produced by electronic components can be dissipated through the plate.

In the imaging device set forth above, preferably:

the plate further holds an auxiliary substrate that is connected electrically to the substrate.

The imaging device, structured as described above, enables a configuration that can be assembled relatively easily, in a structure that has a plurality of substrates, through the plate holding the plurality of substrates.

### BRIEF DESCRIPTIONS OF THE DRAWINGS

FIG. 1 is an assembly perspective diagram of the imaging device.

FIG. 2 is a perspective diagram of the outside of the imaging device.

FIG. 3 is a plan view, viewing the imaging element from the optical axial forward direction.

FIG. 4 is a plan view, viewing the imaging element from the side.

FIG. 5 is a plan view, viewing the imaging element from the optical axial rearward direction.

FIG. 6 is a perspective diagram of an imaging apparatus from which the front case, rear case, and connector have been removed.

FIG. 7 is a plan view, viewing from the optical axial forward direction, an imaging device from which the front case, rear case, and connector have been removed.

FIG. 8 is a plan view, viewing from the side, an imaging device from which the front case, rear case, and connector have been removed.

FIG. 9 is a plan view, viewing from the optical axial rearward direction, an imaging device from which the front case, rear case, and connector have been removed.

FIG. 10 is a cross-sectional diagram at the position of A-A in FIG. 3.

FIG. 11 is a cross-sectional diagram at the position of B-B in FIG. 7.

### DETAILED DESCRIPTION

One distinctive feature of the imaging device according to the present invention is the structure wherein a plate, made of metal, is disposed so as to cover the imaging element, wherein the plate secures the substrate, while biasing it in the optical axial direction, holding it so as to enable movement perpendicular to the optical axis.

An embodiment according to the present invention will be explained, following the structures below. However, the embodiment explained below is no more than an example of the present invention, and must not be interpreted as limiting the technical scope of the present invention. Note that in the various drawings, identical reference symbols are assigned to identical structural elements, and explanations thereof may be omitted.

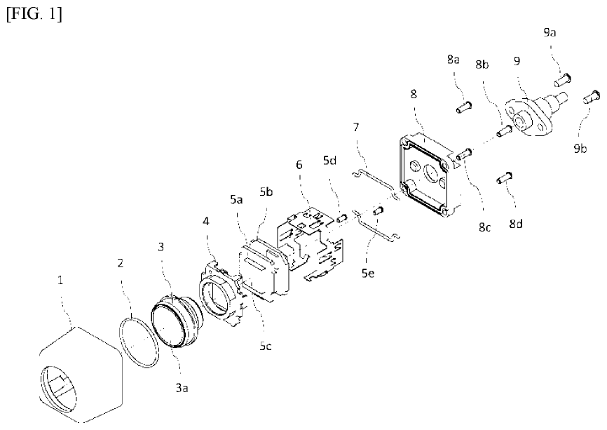

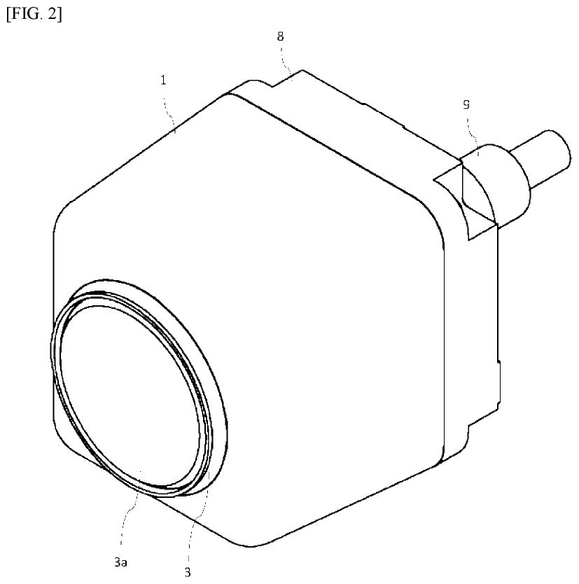

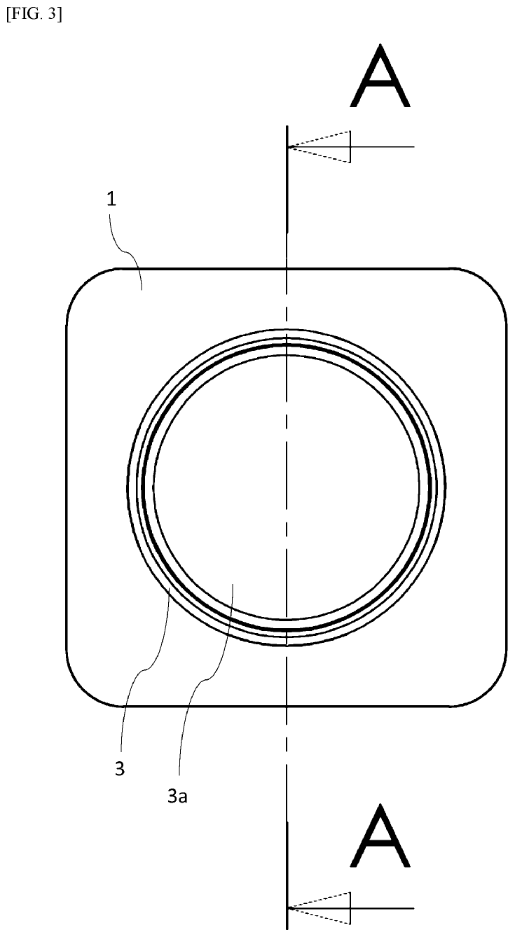

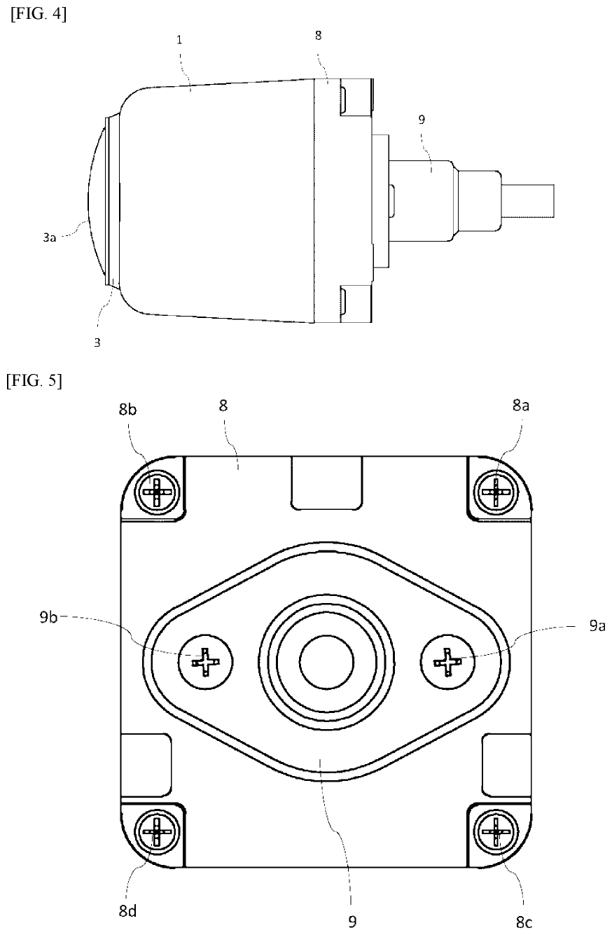

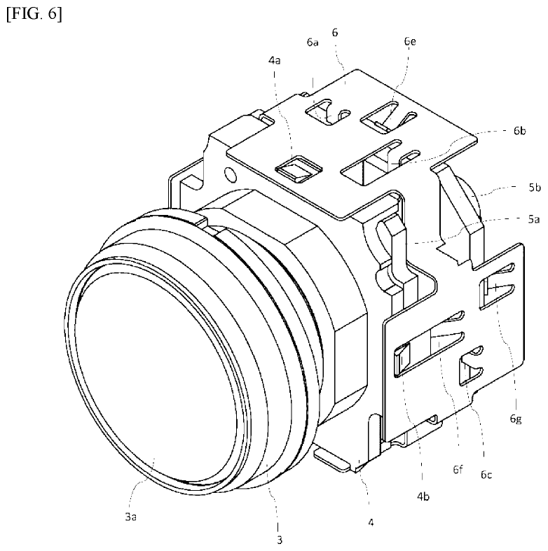

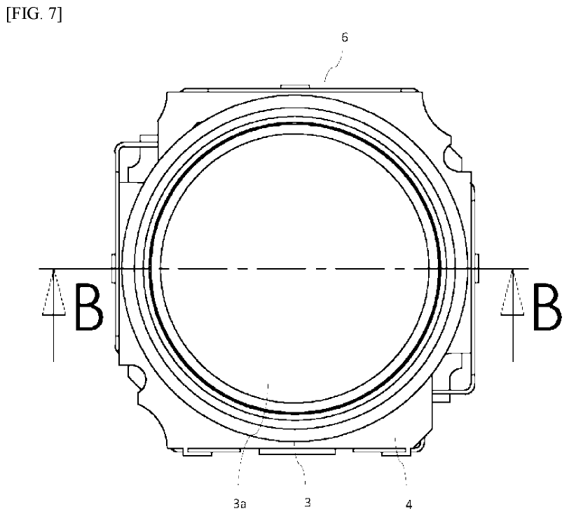

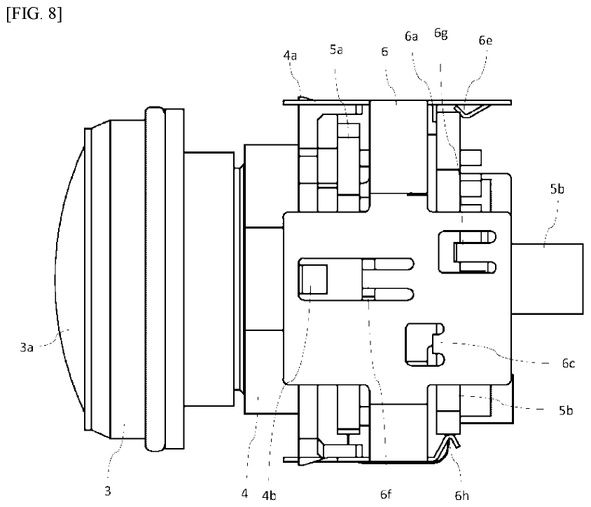

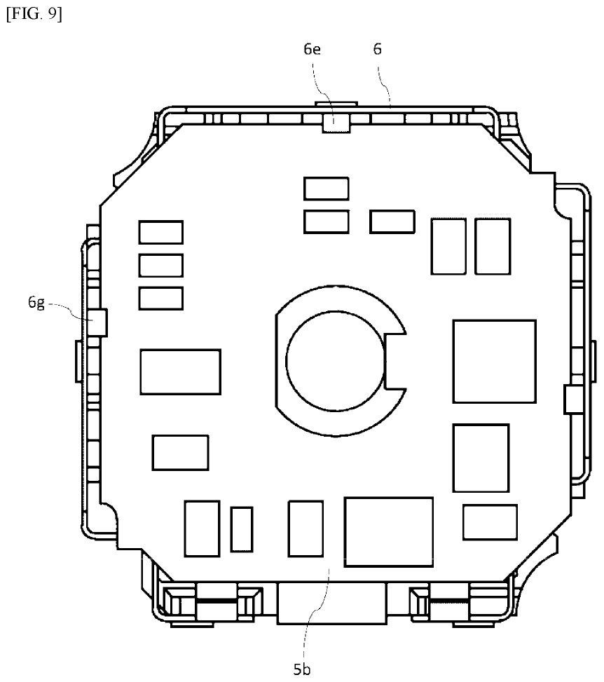

Examples according to the present invention will be explained in reference to the drawings. FIG. 1 is an assembly perspective diagram of the imaging device according to the present embodiment. FIG. 2 through FIG. 5 are each external views of an imaging device, wherein FIG. 2 is an exterior perspective diagram, FIG. 3 is a plan view when viewed from the optical axial forward direction, FIG. 4 is a plan view when viewed from the side (a direction that is perpendicular to the optical axis), and FIG. 5 is a plan view when viewed from the optical axial rearward direction. FIG. 6 through FIG. 9 depict the imaging device in a state wherein the front case 1, the rear case 8, and the connector 9 have been removed. FIG. 6 is a perspective diagram, FIG. 7 is a plan view when viewed from the optical axial forward direction, FIG. 8 is a plan view when viewed from the side, and FIG. 9 is a plan view when viewed from the optical axial rearward direction. In the figures, “C” indicates the optical axis.

Note that in this Specification, the position of the center of the lens, that is, the position of the center of the light that is incident into the imaging element, is termed the “optical axis.” The object that is imaged, positioned on the side of the lens that is opposite from the imaging element, will be termed the “imaging subject.” The direction in which the imaging subject is positioned, in respect lens, is termed “optical axial forward direction,” or “the imaging subject side.” The direction in which the imaging element is positioned, in respect lens, is termed “optical axial rearward direction,” or “the imaging element side.”

As depicted primarily in FIG. 1, the imaging device according to the present embodiment is structured including a front case 1, a waterproofing rubber 2, a lens barrel 3, a lens flange 4, a substrate 5a, an auxiliary substrate 5b, a plate 6, a waterproofing rubber 7, a rear case 8, and a connector 9. The waterproofing rubber 2, the lens barrel 3, the lens flange 4, the substrate 5a, the auxiliary substrate 5b, the plate 6, and the waterproofing rubber 7 are held covered by a case that is structured from the front case 1 and the back case 8.

<Front Case 1, Rear Case 8>

The front case 1 is, in the imaging device, the case that is disposed toward the optical axial forward direction. The rear case 8 is, in the imaging device, the case that is disposed toward the optical axial rearward direction. The front case 1 and the rear case 8 are joined together through connecting screws 8a through 8d. The front case 1 and the rear case 8 each have screw holes into which the connecting screws 8a through 8d are inserted. The screw holes of the rear case 8 are through holes. The rear case 8 and the connector 9 are connected together through connecting screws 9a and 9b.

<Lens Barrel 3>

The lens barrel 3 is a cylindrical member that extends in the optical axial direction. The lens barrel 3 holds at least one optical member, including a lens 3a.

Optical members held in the lens barrel 3 include, in addition to the lens 3a, lenses, spacers, aperture plates, optical filters, and the like (not shown). The lens that includes the lens 3a is formed from a raw material that has transparency, such as glass, plastic, or the like, and refracts and transmits, in the optical axial rearward direction, the light from the optical axial forward direction. The spacers are disk-shaped members having an appropriate thickness in the optical axial direction, to adjust the positions of the individual lenses in the optical axial direction. The spacers have opening portions in the center portions thereof, including the optical axis. The aperture plate determines the outermost position of the light that passes therethrough. The optical filters suppress or block light of prescribed wavelengths. Optical filters include, for example, infrared radiation cut filters that reduce the infrared radiation that passes therethrough. The number of these optical members can be changed arbitrarily.

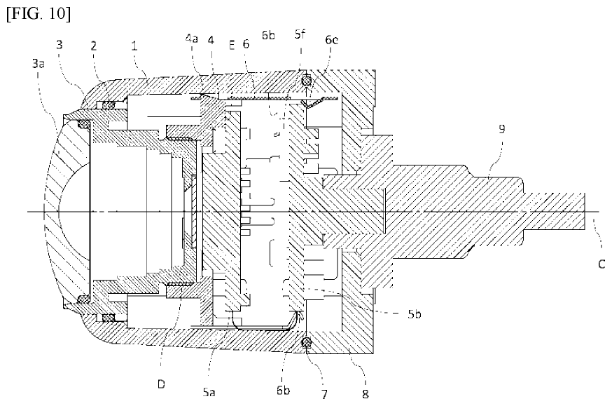

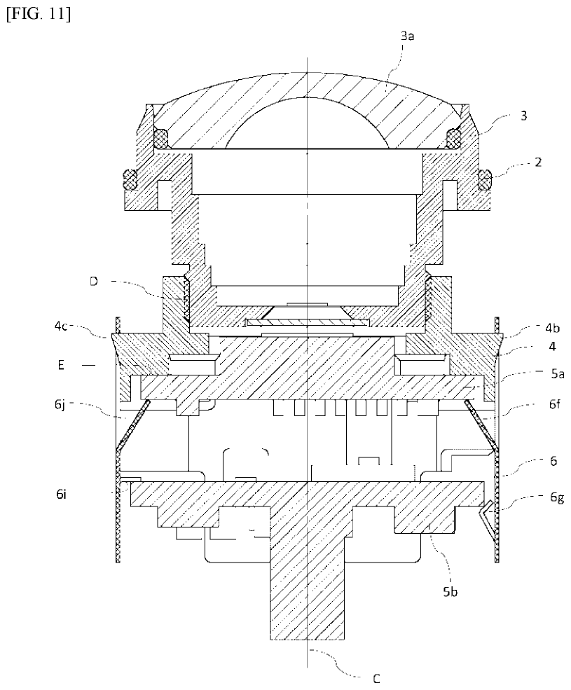

The lens barrel 3 has thread ridges at the position of D in FIG. 10 and FIG. 11, which is the outer peripheral position on the outside in the radial direction. The thread ridges fit with a screw hole that is formed in the inner periphery on the inside, in the radial direction, of the lens flange 4. The amount to which the lens barrel 3 is screwed into the lens flange 4 is adjusted through rotating the lens barrel 3 in respect to the lens flange 4. As described below, because the substrate 5a on which the imaging element 5c is secured in the optical axial direction in respect to the lens flange 4, the position of the lens barrel 3 in the optical axial direction in respect to the imaging element 5c is adjusted through adjusting the amount by which the lens barrel 3 is screwed into the lens flange 4. This makes it possible to adjust the focus.

<Lens Flange 4>

The lens flange 4 has a thread ridge that the position of D in FIG. 10 and FIG. 11, that is, at the position on the inside in the radial direction, as described above. The lens flange 4 is connected by screwing together with the lens barrel 3 through this thread ridge. The lens flange 4 holds the lens barrel 3 thereby. Moreover, the lens flange 4 is held by the plate 6.

The lens flange 4 has hook portions 4a through 4c, positioned to the outside, facing the case 1 (referencing FIG. 6, FIG. 8, FIG. 10, and FIG. 11). The hook portions 4a through 4c each protrude toward the outside, protruding from hole portions formed in the plate 6. The surfaces of the hook portions 4a and 4c in the optical axial forward direction contact the end faces, in the optical axial rearward direction, of the hole portions of the plate 6. Movement of the lens flange 4 in the optical axial forward direction is constrained thereby.

The surface of the lens flange 4 in the optical axial rearward direction contacts the optical axial forward direction surface of the substrate 5a at the position of E in FIG. 10 and FIG. 11. As described below, the substrate 5a receives a biasing force in the optical axial forward direction, and the lens flange 4 is biased, by this biasing force, in the optical axial forward direction. That is, the position of the lens flange 4 is secured in the optical axial direction, while being biased in the optical axial forward direction by the hook portions 4a through 4c and the substrate 5a.

<Substrate 5a>

The substrate 5a is a rigid substrate, and electronic components, including the imaging element 5c, are mounted thereon. The optical axial forward direction surface of the substrate 5a contacts the optical axial rearward direction surface of the lens flange 4 at the position E in FIG. 10 and FIG. 11. In the substrate 5a, the optical axial rearward direction surface contacts the substrate rearward biasing portions 6f and 6j of the plate 6. That is, the substrate 5a is biased elastically, in the optical axial forward direction, by the substrate rearward biasing portions 6f and 6j.

The imaging element 5c is a photoelectric converting element for converting the incident light into electric signals, and is, for example, a CMOS sensor, a CCD, or the like, although there is no limitation thereto.

In the imaging device wherein the optical axis adjustment and the focal adjustment have been completed, the positions are secured through coating, with an adhesive agent, or the like, the position of contact between the lens flange 4 and the substrate 5a.

<Auxiliary Substrate 5b>

The auxiliary substrate 5b is a rigid substrate, on which electronic components, and the like, are mounted. The auxiliary substrate 5b is connected electrically to the substrate 5a, a flexible substrate, and the like.

The electronic components 5f that are mounted on the auxiliary substrate 5b, depicted in FIG. 10 are components that have the properties of producing heat, generating heat during the operation thereof, such as semiconductor devices, or the like. A heat conducting portion 6b that protrudes from the plate 6 contacts the surface of the electronic component 5f. The heat conducting portion 6b extends in the direction that is perpendicular to the optical axis, constraining movement of the electronic component 5f, and of the auxiliary substrate 5b, in the optical axial forward direction. The heat conducting portion 6b conducts the heat of the electronic component 5f, to prevent the electronic component 5f from becoming excessively hot.

Auxiliary substrate forward supporting portions 6a, 6c, and 6i contact the optical axial front surface of the auxiliary substrate 5b, to constrain movement of the auxiliary substrate 5b in the optical axial forward direction.

Auxiliary substrate rearward biasing portions 6e and 6g contact the optical axial back surface of the auxiliary substrate 5b. The auxiliary substrate 5b is biased elastically by the auxiliary substrate rearward biasing portions 6e and 6g in the optical axial forward direction.

There is a cylindrical protruding portion in the optical axial rearward direction of the auxiliary substrate 5b. The protruding portion is inserted into a hole portion of the connector 9.

<Plate 6>

The plate 6 is formed from sheet metal, and is disposed covering the substrate 5a and the auxiliary substrate 5b on the outside, in respect to the optical axis. The plate 6 has functions for preventing electromagnetism generated by the substrate 5a and the auxiliary substrate 5b from leaking to the outside, and for preventing incursion of noise from the outside. Because of this, the plate 6 is also called a “shield plate.”

The plate 6 has bent plate portions wherein the various portions thereof are bent toward the inside, where these bent plate portions serve as the substrate rearward biasing portions 6f and 6j, auxiliary substrate forward supporting portions 6a, 6c, and 6i, auxiliary substrate rearward biasing portions 6e and 6g, the auxiliary substrate biasing portion 6h, and the heat conducting portion 6b. The substrate rearward biasing portions 6f and 6j, the auxiliary substrate rearward biasing portions 6e and 6g, and the auxiliary substrate biasing portion 6h is each in the form of a leaf spring, and has a biasing force.

The substrate rearward biasing portions 6f and 6j contact the optical axial rear of the substrate 5a, to bias it in the optical axial forward direction. The auxiliary substrate rearward biasing portions 6e and 6g contact the optical axial direction rear of the auxiliary substrate 5b, biasing it in the optical axial forward direction. The auxiliary substrate biasing portion 6h supports and biases the auxiliary substrate 5b toward the inside. These substrate rearward biasing portions 6f and 6j are an example of a structure of the “first holding portion” in the present invention.

<Waterproofing Rubbers 2, 7>

The waterproofing rubber 2 is disposed between the front case 1 and the lens barrel 3, preventing the ingress of moisture into the interior. The waterproofing rubber 7 is disposed between the front case 1 and the rear case 8, preventing the ingress of moisture into the interior. The waterproofing rubbers 2 and 7 may be replaced with resin, or the like, or a structure may be used wherein they are not provided.

<Connector 9>

The connector 9 has a hole portion in the center portion thereof in the optical axial forward direction, where the optical axial rearward direction protruding portion of the auxiliary substrate 5b is inserted into this hole portion. The connector 9 is connected to the rear case 8. The connector 9 is connected to the device in which the imaging device has been mounted.

<Optical Axis Adjustment and Focal Adjustment>

In the imaging device structured as set forth above, the optical axial adjustment and focal adjustment can be carried out as described below. As depicted in FIG. 10 and FIG. 11, the lens flange 4 is secured, in the optical axial direction and in the directions perpendicular to the optical axis, to the plate 6. The lens barrel 3 is screwed into the lens flange 4. The lens barrel 3 is moved in the optical axial direction in respect to the lens flange 4 when the lens barrel 3 is rotated in respect to the lens flange 4. That is, the lens barrel 3 can move in the optical axial direction in respect to the plate 6.

On the other hand, the plate 6 secures the substrate 5a so as to not move in the optical axial direction, supporting it so as to enable movement in the directions perpendicular to the optical axis.

Consequently, the substrate 5a can move in the directions perpendicular to the optical axis, and the lens barrel 3 can move in the optical axial direction, in respect to the plate 6. Thus the optical axial position can be adjusted by moving the substrate 5a, and the focus can be adjusted by rotating the lens barrel 3. Once the adjustments to the optical axial position and focus have been completed, then the position of contact between the lens flange 4 and the substrate 5a is adhesively bonded. If necessary, other locations may also be adhesively bonded as well.

Through this, the imaging device according to the present embodiment enables optical axis adjustment and focal adjustment to be carried out more easily and with greater precision than with the conventional structure.

Moreover, in the imaging device according to the present embodiment, portions of the plate 6 are structured in the form of leaf springs, to support, and bias in the optical axial direction, the substrate 5a, thus enabling the substrate 5a to be held with stability, without increasing the number of components.

### 2. Supplementary Items

An embodiment according to the present invention was explained in detail above. The explanation above is no more than an explanation of one form of embodiment, and the scope of the present invention is not limited to this form of embodiment, but rather is interpreted broadly, in a scope that can be understood by one skilled in the art.

While, in the embodiment, the lens flange 4 is secured to the plate 6 and the substrate 5a is able to move in the directions that are perpendicular to the optical axis, instead the structure may be one wherein the substrate 5a is secured to the plate 6, with the lens flange 4 able to move in the directions that are perpendicular to the optical axis. In this configuration as well, the optical axis can be adjusted, through moving the substrate in the directions perpendicular to the optical axis.

The imaging device according to the present invention is particularly useful as an imaging device to mounted in a vehicle, such as an automobile, which requires the optical axis to be adjusted with particularly high precision.

### POTENTIAL FOR USE IN INDUSTRY

The present invention can be used suitably for imaging devices, or the like, for vehicle mounting.

We claim:

1. An imaging device, comprising:
a substrate mounting an imaging portion;
a lens barrel holding a lens;
a lens flange holding the lens barrel; and
a plate holding the substrate and the lens flange, wherein the plate comprises a first holding portion holding either the substrate or the lens flange while biasing in an optical axial direction, and holding the other, of the substrate or the lens flange, so as to enable movement in a direction that is perpendicular to the optical axis,
wherein the other, of the substrate or the lens flange, is secured to the plate.

2. The imaging device as set forth in claim 1, wherein:
the plate is metal and arranged so as to cover the substrate.

3. The imaging device as set forth in claim 1, wherein:
the first holding portion is a leaf spring portion of the plate.

4. The imaging device as set forth in claim 1, further comprising:
an electronic component; and
wherein the plate further comprises a heat conducting portion that contacts the electronic component.

5. The imaging device as set forth in claim 1, wherein:
the plate further holds an auxiliary substrate that is connected electrically to the substrate.
